(19) United States
(12) Patent Application Publication
(10) Pub. No.: US 2018/0014484 A1
(43) Pub. Date: Jan. 18, 2018

(54) VERTICAL HYDROPONICS CULTIVATION EQUIPMENT

(71) Applicants: D-Glatt Co., Ltd., Tokyo (JP); WISSEN Co., Ltd., Tokyo (JP)

(72) Inventor: Masao YOSHIDA, Tokyo (JP)

(21) Appl. No.: 15/209,334

(22) Filed: Jul. 13, 2016

(51) Int. Cl. A01G 31/06; A01G 31/00

(52) U.S. Cl. CPC A01G 31/06; A01G 2031/006

(57) ABSTRACT

Vertical hydronics cultivation equipment including a vertical flow path formation opposed panel retained by a frame body. The vertical flow path formation opposed panel includes a pair of plates that are parallelly opposed to each other and a block section blocking both sides of the plate. The pair of plates have therebetween a nutrient solution flow path that has a predetermined width in a horizontal direction to the floor face and that extends in a vertical direction to the floor face. The vertical flow path formation opposed panel has a plurality of retention holes through which the plant retention member is inserted. The frame body includes a nutrient solution tank, a spray bar, a hollow connecting member connecting the spray bar to the outlet of the nutrient solution tank, a gutter for guiding the nutrient solution to the tank, a circulation pump, and a controller for controlling the circulation pump.

### BACKGROUND OF THE INVENTION

The present invention relates to vertical hydronics cultivation equipment to cultivate a plant by allowing nutrient solution to vertically flow from an upper part to a lower part so that the flow of this nutrient solution is circulated.

Transportable container-type crop cultivation equipment has been known that has a function to control an artificial light source, air conditioning and additional fertilization for example (e.g., Japan Utility Model Registration No. 3189886).

Crop cultivation equipment in which facilities such as an artificial light source, air conditioning and additional fertilization are included in a container requires a large size and a large footprint. Thus, such equipment cannot be easily installed in a small space in a store or a general living space.

It is an objective of the present invention to provide hydronics cultivation equipment by which the hydronics cultivation of crops can be easily carried out in a store or a general living space.

### SUMMARY OF THE INVENTION

In order to achieve the above objective, the present invention is characterized in the following point. The present invention includes a frame body (2), a vertical flow path formation opposed panel (3) retained by the frame body (2), a nutrient solution tank (6) storing plant nutrient solution, a spray bar (12) that is provided at the upper side of the vertical flow path formation opposed panel (3) and that has a spray hole, a hollow connecting member (14) that connects the spray bar (12) to the outlet of the nutrient solution tank (6), a nutrient solution receiving means that guides the nutrient solution discharged from the lower part of the vertical flow path formation opposed panel (3) to the tank (6), and a circulation pump (7) that supplies the nutrient solution in the nutrient solution tank (6) to the hollow connecting member (14). The vertical flow path formation opposed panel (3) is composed of a pair of plates that are parallelly opposed to each other to mutually have a predetermined interval and a block section (3C) blocking both sides of the plate. The pair of plates have therebetween a nutrient solution flow path (10) that has a predetermined width in a horizontal direction to the floor face and that extends in a vertical direction to the floor face. At least one of the pair of plates includes therein a plurality of retention holes (9) communicating with the nutrient solution flow path (10) through which a plant retention member (11) is inserted. The pump (7) is driven to supply the nutrient solution in the nutrient solution tank (6) to the spray bar (12) through the hollow connecting member (14) and the nutrient solution is circulated in the nutrient solution flow path (10).

The present invention is also characterized in that the pair of plates of the flow path formation opposed panel (3) are composed of a pair of corrugated plates (3a) and (3b) that are parallelly opposed to each other to mutually have a predetermined interval. The corrugated plates (3a) and (3b) include a step section (D). The step section (D) includes therein the retention hole (9) connected to the nutrient solution flow path (10) through which the plant retention member (11) is inserted. The pump (7) is driven to circulate the nutrient solution in the nutrient solution tank (6) in the nutrient solution flow path (10).

The present invention is also characterized in that the frame body (2) includes therein an LED plant nurturing light (4) to nurture plants.

The present invention is also characterized in that the frame body (2) is attached with a controller (8) to control the circulation pump (7) and the controller (8) controls the circulation pump (7) to allow intermittent operation.

According to the present invention, the frame body can be placed in a store or a room. Thus, the hydronics cultivation can be easily carried out in a store or a room.

### BRIEF DESCRIPTION OF THE DRAWINGS

FIG. 1 illustrates the entire appearance of cultivation equipment according to the present invention.

FIG. 2 illustrates the appearance of a part of the present invention.

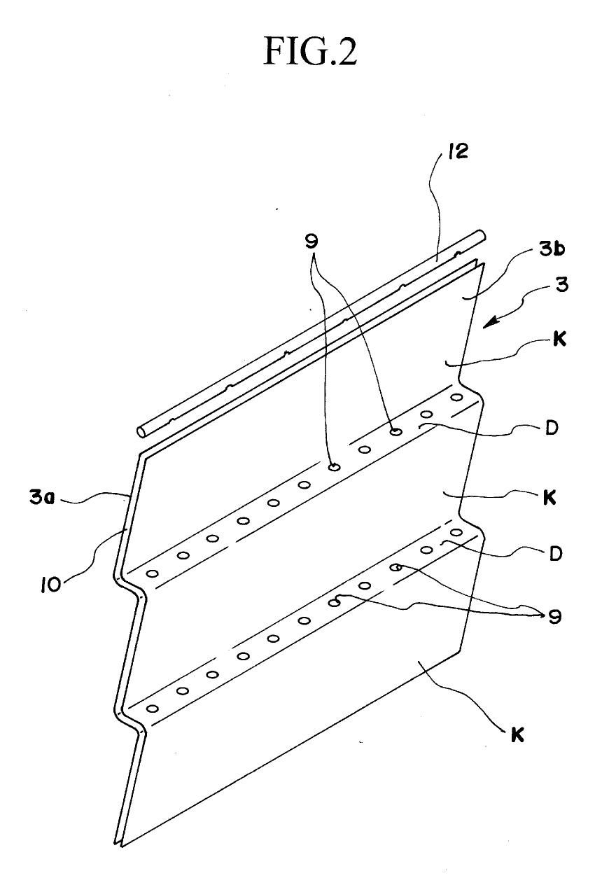

FIG. 3 illustrates a part of the present invention.

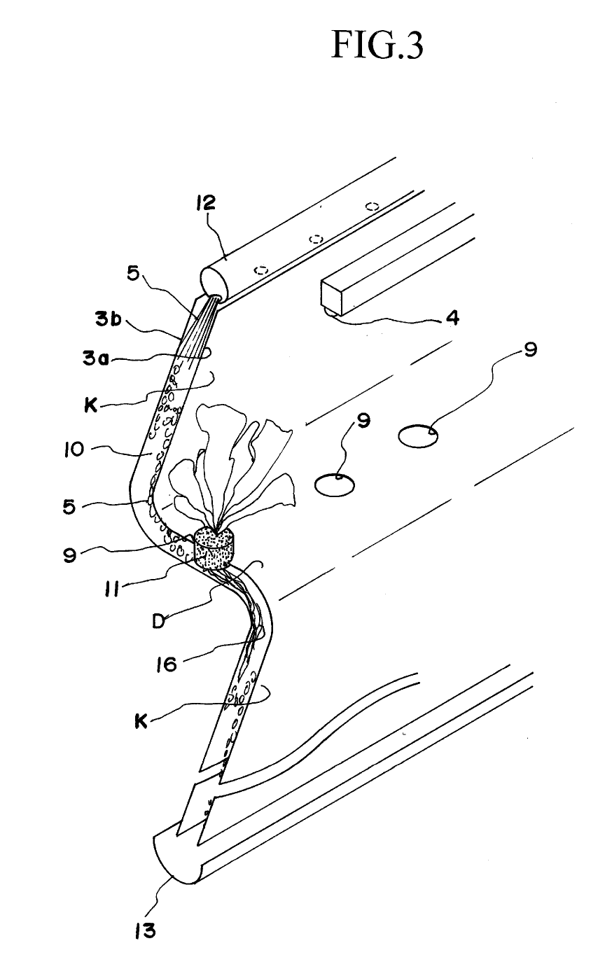

FIG. 4 illustrates a part of the present invention.

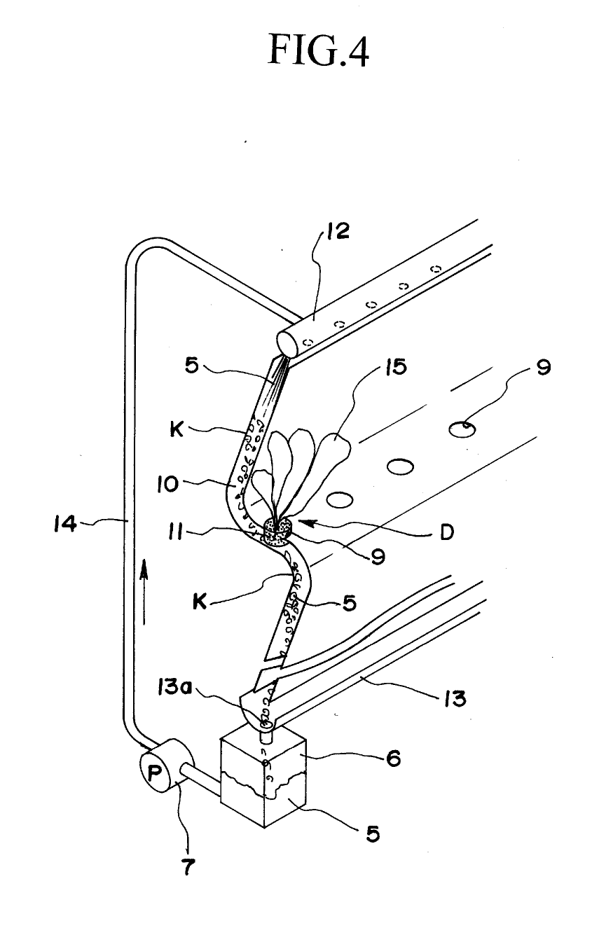

### EMBODIMENT FOR CARRYING OUT THE INVENTION

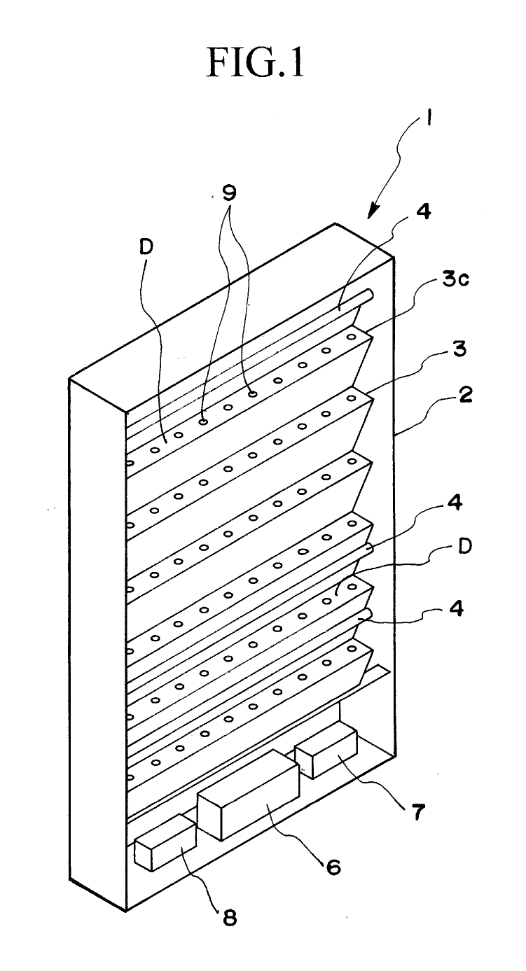

The following section will describe the configuration of the present invention with reference to the attached drawings. FIG. 1 illustrates the entirety of the vertical hydronics cultivation equipment according to the present invention. The cultivation equipment 1 is configured so that both side plates of a transportable frame body 2 retain therebetween a vertical flow path formation opposed panel 3 and an LED plant nurturing light 4. The bottom of the frame body 2 has a nutrient solution tank 6 including therein the nutrient solution 5, a circulation pump 7 and a controller 8 to control the pump 7 and the LED plant nurturing light 4 for example.

The opposed panel 3 has a pair of ABS resin-made corrugated plates 3a and 3b mutually opposed in a parallel manner to have a predetermined interval. A nutrient solution flow path 10 is formed between the corrugated plates 3a and 3b that has a predetermined width in a direction horizontal to the floor face and that extends in a vertical direction. The pair of corrugated plates 3a and 3b and block sections 3C at both sides are configured by integrally molding ABS resin material.

In this embodiment, the opposed panel 3 uses ABS resin. However, the material is not limited to synthetic resin and metal and other appropriate materials can be used. The pair of corrugated plates 3a and 3b includes a plurality of inclined sections K and a step section D between the upper and lower inclined sections K, K. Each step section D constitutes a plant arrangement area inclined to the floor face by a predetermined angle.

Each plant arrangement area has a plurality of retention holes 9 formed to have a predetermined interval in a lateral direction. Each retention hole 9 is configured so as to receive a retention member 11 such as sponge in which a nursery plant or seed is buried. The upper part of the frame body 2 has a spray bar 12 consisting of a pipe including a nozzle hole. The nozzle hole of the spray bar 12 is opposed to the upper end opening of the nutrient solution flow path 10.

The lower side of the flow path 10 has a gutter 13. A discharge hole 13a formed at the center of the gutter 13 communicates with the nutrient solution tank 6 via a pipe body. The nutrient solution tank 6 and the spray bar 12 are connected via a hollow connecting member 14 consisting of a pipe. The communication path of the hollow connecting member 14 is connected to the pump 7. The hollow connecting member 14 can be a pipe or a tube or other appropriate hollow connecting tools.

The driving section of the pump 7 and the electronic circuit section of the LED plant nurturing light 4 are electrically connected to the controller 8. The pump 7 and the LED plant nurturing light 4 are configured so that the drive can be controlled by the controller 8. The vertical flow path formation opposed panel 3 may be configured so that the entirety may be integrally machined or the respective sections also may be molded and may be joined. The frame body 2 is provided on the floor face in a room such as a store or a living space or is provided on the floor face of a building such as a warehouse.

In the above-described configuration, a nursery plant or a seed retained by the retention member 11 such as a sponge and the retention member 11 are inserted to the retention hole 9 of the plant arrangement area of the opposed panel 3. On the other hand, the circulation pump 7 is driven to supply the nutrient solution 5 in the nutrient solution tank 6 to the spray bar 12 through the pipe 14. The nutrient solution 5 is sprayed through the spray bar 12 toward the upper part of the flow path 10. The nutrient solution 5 sprayed to the upper part of the flow path 10 is allowed to flow in the flow path 10 to fall on the gutter 13 and is allowed to return to the interior of the nutrient solution tank 6. The gutter 13 constitutes a nutrient solution receiving means that guides the nutrient solution having passed the flow path 10 to the tank 6.

In this manner, the nutrient solution 5 in the nutrient solution tank 6 is circulated from the upper side to the lower side in the flow path 10 through the hollow connecting member 14. The plant nurturing light 4 irradiates the retention member 11 to nurture the plant. Although the nutrient solution circulation pump 7 may be operated continuously, the intermittent operation of the nutrient solution circulation pump 7 can save electric energy. The intermittent operation of the pump 7 also can allow a root 16 of a plant 15 to have a contact with air to thereby improve the growth of the plant 15.

In this embodiment, the step section D is protruded to the front side of the opposed panel 3 and a plant is nurtured at the front face side of the frame body 2. However, another structure may be used in which the step section D is also protruded to the rear side and plants are nurtured at both face sides of the frame body 2.

What is claimed is:

1. A vertical hydronics cultivation equipment, comprising a frame body, a vertical flow path formation opposed panel retained by the frame body, a nutrient solution tank storing plant nutrient solution, a spray bar that is provided at the upper side of the vertical flow path formation opposed panel and that has a spray hole, a hollow connecting member that connects the spray bar to the outlet of the nutrient solution tank, a nutrient solution receiving means that guides the nutrient solution having passed the vertical flow path formation opposed panel to the tank, and a circulation pump that supplies the nutrient solution in the nutrient solution tank to the hollow connecting member, wherein the vertical flow path formation opposed panel is composed of a pair of plates that are parallelly opposed to each other to mutually have a predetermined interval and a block section blocking both sides of the plate, the pair of plates have therebetween a nutrient solution flow path that has a predetermined width in a horizontal direction to the floor face and that extends in a vertical direction to the floor face, at least one of the pair of plates includes therein a plurality of retention holes communicating with the nutrient solution flow path through which the plant retention member is inserted, the pump is driven to circulate the nutrient solution in the nutrient solution tank up and down in the nutrient solution flow path.

2. The vertical hydronics cultivation equipment according to claim 1, wherein the pair of plates of the flow path formation opposed panel are composed of a pair of corrugated plates that are parallelly opposed to each other to mutually have a predetermined interval, the corrugated plate includes a step section, the step section includes therein a retention hole connected to the nutrient solution flow path through which the plant retention member is inserted, the pump is driven to circulate the nutrient solution in the nutrient solution tank in the nutrient solution flow path.

3. The vertical hydronics cultivation equipment according to claim 1, wherein the frame body includes therein an LED plant nurturing light to nurture plants.

4. The vertical hydronics cultivation equipment according to claim 1, wherein the frame body is attached with a controller to control the circulation pump and the controller controls the circulation pump to allow intermittent operation.
